(19) United States
(12) Patent Application Publication
(10) Pub. No.: US 2003/0026313 A1
(43) Pub. Date: Feb. 6, 2003

(54) Polarization control of a VCSEL using an external cavity

(75) Inventors: Michael V. Morelli, San Jose, CA (US); John Epler, Milpitas, CA (US)

Correspondence Address: Timothy A. Brisson, Sierra Patent Group, Ltd., P.O. Box 6149, Stateline, NV, 89449, US

(73) Assignee: Siros Technologies, Inc.

(21) Appl. No.: 09/919,333

(22) Filed: Jul. 30, 2001

Related U.S. Application Data
(63) Continuation-in-part of application No. 09/817,362, filed on Mar. 20, 2001.
(60) Provisional application No. 60/263,060, filed on Jan. 19, 2001.
(60) Provisional application No. 60/303,479, filed on Jul. 6, 2001.

(51) Int. Cl. H01S 3/10; H01S 3/08

(52) U.S. Cl. 372/92; 372/105

(57) ABSTRACT

A light source is disclosed. In one aspect, a gain region defined by a first and second mirror is provided having a corresponding resonant mode, and an external cavity defined by a third mirror and the second mirror is also provided having a plurality of resonant modes. A birefringent crystal is then disposed within said external cavity for the purpose of controlling the state of polarization.

### RELATED APPLICATIONS

This application is a continuation in part of U.S. application Ser. No. 09/817,362, filed Mar. 20, 2001. This application also claims the benefit of U.S. Provisional Applications No. 60/263,060, filed Jan. 19, 2001; and No. 60/303,479, filed Jul. 6, 2001, Attorney Docket No. Siros-035P.

### BACKGROUND

1. Field of the Disclosure

The disclosure relates generally to lasers, and in particular, to Vertical Cavity Surface Emitting Lasers (VCSEL).

2. The Prior Art

### BACKGROUND

Vertical Cavity Surface Emitting Lasers (VCSELs) are well known in the art (see, e.g. Wilmsen, Temkin and Coldren, et. al. “Vertical Cavity Surface Emitting Lasers”, 2nd Edition). They have found extensive use in short-distance (<1 km) and moderate speed (<=1 Gb/s) data communications applications.

VCSEL have several advantages over their main competitor, edge emitting lasers. For example, VCSELs can be tested in wafer-form. This is less expensive than testing individual devices, as must be done with edge emitters. Wafer testing also allows defective devices to be culled early in the process, before additional fabrication expenses have been invested. Furthermore, VCSELs emit a beam of light whose intensity profile is circular, rather than elliptical, as is the case for edge emitters. Circular beams couple more efficiently into optical fibers. Moreover, VCSEL manufacturing yield is higher than edge emitter yield because the critical mirrors are formed using semiconductor manufacturing processes rather than mechanical cleaving of the wafer. Finally, VCSELs are more reliable because of a lower density of defects in the mirrors.

However, for longer distance and higher speed telecommunications applications, edge-emitting lasers remain dominant for several reasons. For example, edge emitters can be designed to operate at a wavelength of 1550 nm (as opposed to 850 nm which is typical for VCSELs). This wavelength suffers much less attenuation as it propagates through optical fiber, enabling longer distance transmission. Furthermore, edge emitters can be designed to have high power—40 mW or more—compared to a few mW for VCSELs. This high power also enables longer distance transmission. Finally, edge emitters produce light of a single polarization. This characteristic can be critical where the light is passed through polarization-sensitive equipment.

Improvements in VCSEL technology has solved some of the disadvantages listed above. For example, VCSELs have been developed which emit light at a wavelength of 1550 nm (see, e.g. J. Boucart, et. al. “1-mW CW-RT Monolithic VCSEL at 1.55 mm”, IEEE Photonics Technology Letters, Vol. 11, No. 6, June 1999).

However, polarization control of VCSEL emissions remains a challenge. Conventional VCSEL structures produce linearly polarized emission, however, the azimuthal angle of the polarization state is typically random from device-to-device within the same wafer. Wafer-level fabrication of these devices with a known polarization state is difficult, and this lack of control potentially compromises their wider application as telecom/datacomm transmitters.

Polarization control provides many desirable device and system-level benefits, including: a) low insertion loss into polarization dependent components, such as optical isolators, wavelockers, or modulators; b) high modulation depth in polarization dependant modulators; c) reduced modulation dependent polarization “chirp” in directly modulated sources; d) elimination of polarization state drift over the lifetime of the device; e) precise intra-package tapping of beam for power monitor or wavelocker; and f) simplified intra-package mounting and alignment of laser and components.

Methods have been developed in the prior art to control the polarization state of VCSELs. Two prior art methods include modifying the wafer with strain inducing structures or sub-wavelength wire grid polarizes or, following the laser with a conventional external polarization converting device. However, these methods suffer from certain disadvantages. For example, wafer-based modifications may complicate the fabrication process, and thus potentially compromise yield. Additionally, they can introduce losses (as in the case of the polarizer), and have the potential to produce a signal dependent polarization state (i.e., polarization state chip). External polarization converters may introduce loss or consume substantial package volume.

### SUMMARY

A single or multi-frequency light source is disclosed. In one aspect, a gain region defined by a first and second mirror is provided having a corresponding resonant mode, and an external cavity defined by a third mirror and the second mirror is also provided having a plurality of resonant modes. A birefringent crystal is then disposed within the external cavity.

In a further aspect of a disclosed light source, the birefringent crystal is configured to receive a light beam and refract the light beam into two orthogonal polarization states. The birefringent crystal may be further configured to impose a higher coupling loss on one of the polarization states. The light source may be further configured to cause one of the polarization states to follow an optical path of low round-trip loss, and the other the polarization state to follow a path of high round-trip loss. Additionally, the birefringent crystal is oriented such that the polarization states experience different indices of refraction.

In a further aspect of a disclosed light source the birefringent crystal is epoxied to the external cavity thereby forming a crystal/epoxy junction having an predetermined optical loss. The index of refraction of the birefringent crystal may be matched with the crystal/epoxy junction optical loss such that the losses of one of the polarization state is minimized.

### BRIEF DESCRIPTION OF THE DRAWING FIGURES

FIG. 1 is a conceptual diagram of one aspect of a disclosed light source;

FIG. 2 is a more detailed conceptual diagram of one aspect of a light source;

FIG. 3 is a plot of the resonant modes of one aspect of a disclosed system;

FIG. 4 is a schematic diagram of one aspect of a disclosed external cavity;

FIGS. 5A-5C are diagrams of a beam-walkoff aspect of the present disclosure; and

FIG. 6 is a plot of the difference in Fabry-Perot spacing.

### DETAILED DESCRIPTION

Persons of ordinary skill in the art will realize that the following description is illustrative only and not in any way limiting. Other modifications and improvements will readily suggest themselves to such skilled persons having the benefit of this disclosure. In the following description, like reference numerals refer to like elements throughout.

The following references are hereby incorporated by reference into the detailed description of the preferred embodiments, and also as disclosing alternative embodiments of elements or features of the preferred embodiment not otherwise set forth in detail above or below or in the drawings. A single one or a combination of two or more of these references may be consulted to obtain a variation of the preferred embodiment described above. In this regard, further patent, patent application and non-patent references, and discussion thereof, cited in the background and/or elsewhere herein are also incorporated by reference into the detailed description with the same effect as just described with respect to the following references:

U.S. Pat. No. 5,347,525, 5,526,155, 6,141,127, and 5,631,758;

Wilmsen, Temkin and Coldren, et al., “Vertical Cell Surface Emitting Lasers, 2nd edition;

Ulrich Fiedler and Karl Ebeling, “Design of VCSELs for Feedback Insensitive Data Transmission and External Cavity Active Mode-Locking”, IEEE JSTQE, Vol. 1, No. 2 (June 1995); and

J. Boucart, et al., 1-mW CW-RT Monolithic VCSEL at 1.55 mm, IEEE Photonics Technology Letters, Vol. 11, No. 6 (June 1999).

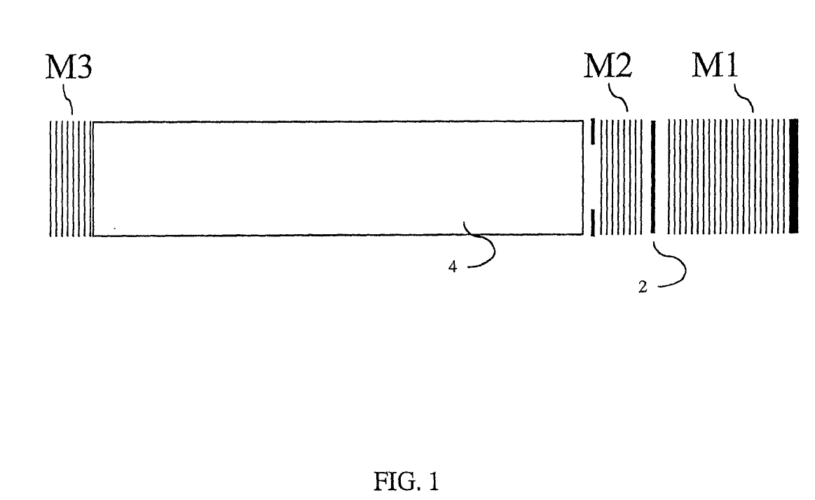

FIG. 1 is conceptual diagram of a light source and illustrates a three-mirror composite-cavity VCSEL configured in accordance with the teachings of this disclosure. The light source includes epitaxially-grown mirrors M1 and M2, and an external mirror M3. In operation, mirror M3 controls frequency spacing modes and provides coupling of the laser energy. The combination of these mirrors defines two cavities: the VCSEL resonant cavity 2, or gain cavity 2, defined by M1 and M2; and an external cavity 4 defined by M2 and M3.

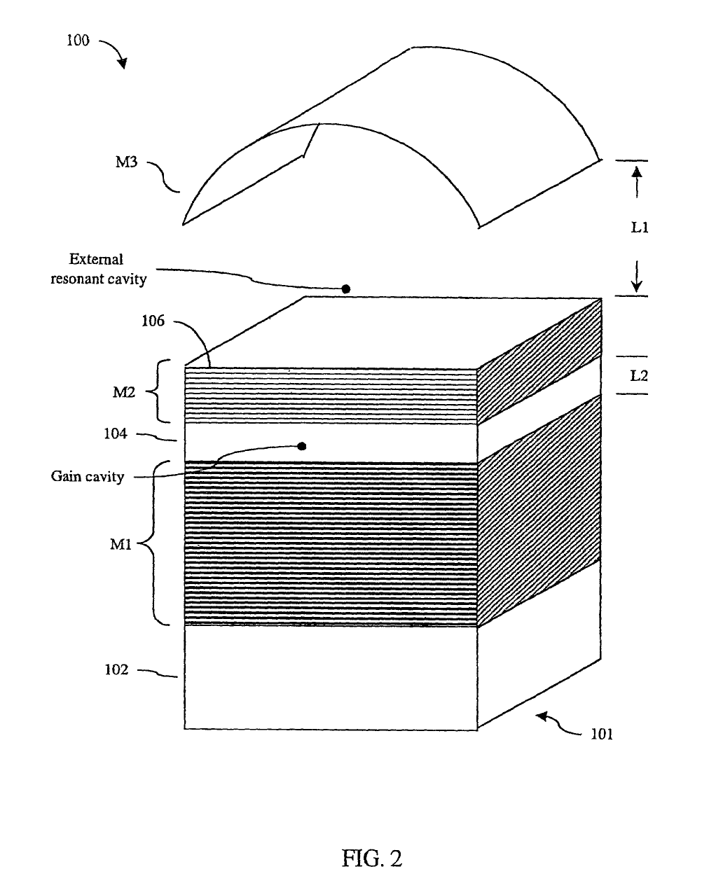

FIG. 2 is a more detailed conceptual diagram of one aspect of a disclosed light source 100. The light source 100 may include a VCSEL 101 having a substrate 102. The substrate 102 may be formed from materials known in the art such as Gas or InP depending on the desired wavelength.

On top of the substrate 102 a mirror M1 is formed. The layers of M1 may be formed epitaxially using techniques known in the art. If the substrate 102 comprises GaAs, then the layers of M1 may be formed from alternating layers of AlGaAs/GaAs for use in the wavelength range of 780-980 nm. Alternatively, if the substrate 102 comprises InP, the layers of M1 may be formed of alternating layers of InGaAlAs/InP for use in the wavelength range of 1300-1700 nm. An active layer 104 for amplifying light is then grown on M1. The active layer 104 may comprise a quantum well active layer fashioned from the same material as M1. The active layer 104 may be formed to a length L1. The active layer 104 will have a gain response and a nominal peak frequency associated therewith. In one aspect of a disclosed light source, the active layer 104 may have a nominal peak frequency of 1550 nm. The nominal peak frequency is typically a function of variables such as current or temperature.

A mirror M2 may then be grown on the active layer 104 using techniques similar to M1.

The light source 100 may further include a mirror M3 disposed a distance L2 from the upper surface of M2.

A light source 100 is thus formed including a VCSEL 101 and an external mirror M3 wherein several alternative designs and variations may be possible. The light source 100 may be described in terms of the distance L1 between mirrors M1 and M2 forming a internal, or gain, cavity and the distance L2 between mirrors M2 and M3 forming an external cavity.

In general, the cavity length of the external cavity may be greatly extended compared with a conventional VCSEL device. The external cavity may be, e.g., between a few hundred microns and several millimeters, and is particularly preferred around 2-3 mm in physical length for a mode-spacing of 50 GHz. For example, at 50 GHz and for a refractive index n=1 (such as for an air or inert gas filled cavity), then the cavity will have a physical length L2 of about 3 mm, which provides a 3 mm optical path length corresponding to 50 GHz. For a cavity material such as glass, e.g., n=1.5, then the physical length will be around 2 mm to provide the optical path length of 2 mm×1.5=3 mm, again corresponding to a 50 GHz mode spacing.

The distance L2 and thus the cavity length may be increased to reduce the mode-spacing. For example, by doubling the cavity length, e.g., to 4-6 mm, the mode-spacing may be reduced to 25 GHz, or by again doubling the cavity length, e.g., to 8-12 mm, the mode-spacing may be reduced to 12.5 GHz. The mode-spacing may be increased, if desired, by alternatively reducing the cavity length, e.g., by reducing the cavity length to half, e.g., 1-1.5 mm to increase the mode-spacing to 100 GHz. Generally, the mode-spacing may be advantageously selected by adjusting the cavity to a corresponding cavity length. The device of the preferred embodiment may utilize other means for reducing the mode-spacing as understood by those skilled in the art.

This extension of cavity length from that of a conventional VCSEL is permitted by the removal or partial removal of a mirrored reflector surface of the mirror M2 and inclusion of mirror M3. The light source 100 and in particular the mirror M3 may be formed as disclosed in co-pending U.S. Ser. No. 09/817,362, filed Mar. 20, 2001, and assigned to the same assignee of the present application, and incorporated by reference as though set forth fully herein.

The extension of the external cavity out to 1.5-15 mm permits a 10-100 GHz mode spacing, since the cavity will support a number of modes having a spacing that depends on the inverse of the cavity length (i.e., c/2 nL, where n is the refractive index of the cavity material and L is the cavity length). The VCSEL with external cavity device for providing single or multiple channel signal output according to a preferred embodiment herein is preferably configured for use in the telecom band around 1550 nm, and alternatively with the telecom short distance band around 1300 nm or the very short range 850 nm band. In the 1550 nm band, 100, 50, 25 and 12.5 GHz cavities are of particular interest as they correspond to standard DWDM channel spacings.

The light source 100 may be around 15 microns tall and preferably comprises a gain medium of InGaAsP or InGaAs and InGaALAs or In GaAsP or AlGaAs mirrors (or mirrors formed of other materials according to desired wavelengths as taught, e.g., in Wilmsen, Temkin and Coldren, et al., “Vertical Cavity Surface Emitting Lasers, 2nd edition, Chapter 8).

The light source 100 may be formed in a variety of manners. For example, the second mode spacing cavity may be formed by a solid lens of either conventional or gradient index design, and may be formed of glass. When a gradient index lens is used, the index of refraction of the material filling the cavity varies (e.g., decreases) with distance from the center optical axis of the resonant cavity. Such GRIN lens provides efficient collection of the strongly divergent light emitted from the laser cavity. In an embodiment using a GRIN lens, the mirrored surface of mirror M3 may be curved or flat, depending on design considerations.

The mirror M3 may have one or more coatings on its remote surface such that it efficiently reflects incident light emitted from the VCSEL 101 as a resonator reflector, preferably around 1550 nm for the telecom band. The mirror M3 is preferably formed of alternating high and low refractive index materials to build up a high reflectivity, such as alternating quarter-wavelength layers of TiO2/SiO2 or other such materials known to those skilled in the art.

The radius of curvature of may be around the length the second cavity. Emitted radiation from the VCSEL 101 diverging outward from the gain region will be substantially reflected directly back into the gain region when the radius of curvature is approximately the cavity length, or around 2-3 mm for a 50 GHz mode-spacing device.

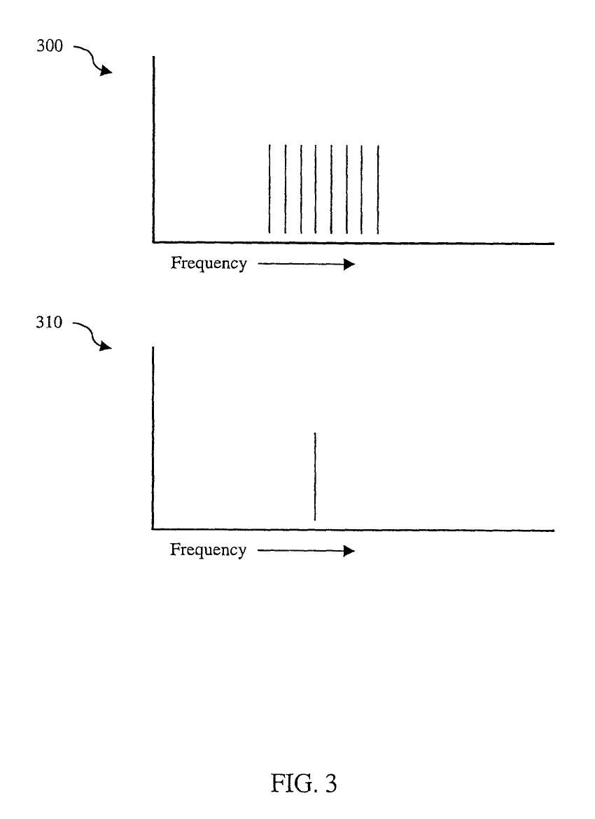

The two cavities of the light source 100 will each have corresponding resonant modes associated therewith, as illustrated in FIG. 3. The resonant modes for the external cavity defined by the distance L2 are shown as plot 300, and corresponding resonant mode plot for the gain cavity defined by the distance L1 is shown as plot 310.

In operation, the cavities provide one or more resonant nodes at optical frequencies for which the roundtrip gain exceeds the loss. For a longer cavity such as the external cavity, the resonant nodes form a comb of frequencies having a separation inversely proportional to the cavity length. For example, for a cavity optical length of 3 mm, the optical spacing of the modes is approximately 50 GHz. Thus, many such nodes will fit within the gain bandwidth of the gain material.

The present disclosure provides VCSEL polarization control by introducing an appropriately oriented and dimensioned bulk uni- or bi-axial birefringent crystal into the optical path of the external cavity (EC).

FIG. 4 is a schematic diagram of one aspect of a disclosed external cavity 400 including a mirror M3 as described above. In the embodiment of FIG. 4, a birefringent crystal 402 is placed in the optical path of the beam incident to the external cavity. It is contemplated that any wide variety of birefringent materials known in the art may be employed. Examples of crystals suitable for use are disclosed in Table 1.

| Oniaxial: | | nₒ | | nₑ |
|---|---|---|---|---|
| positive | Ice | 1.309 | | 1.310 |
| | Quartz | 1.544 | | 1.553 |
| | BeO | 1.717 | | 1.732 |
| | Zircon | 1.923 | | 1.968 |
| | Rutile | 2.616 | | 2.903 |
| | ZnS | 2.354 | | 2.358 |
| negative | (NH₄)H₂PO₄(ADP) | 1.522 | | 1.478 |
| | Beryl | 1.598 | | 1.590 |
| | KH₂PO₄(KDP) | 1.507 | | 1.467 |
| | NaNO₃ | 1.587 | | 1.336 |
| | Calcite | 1.658 | | 1.486 |
| | Tourmaline | 1.638 | | 1.618 |
| | LiNbO₃ | 2.300 | | 2.208 |
| | BaTiO₃ | 2.416 | | 2.364 |
| | Proustite | 3.019 | | 2.739 |
| Biaxial | | nₓ | n_{y} | n_{z} |
| | Gypsum | 1.520 | 1.523 | 1.530 |
| | Feldspar | 1.522 | 1.526 | 1.530 |
| | Mica | 1.552 | 1.582 | 1.588 |
| | Topaz | 1.619 | 1.620 | 1.627 |
| | NaNO₂ | 1.344 | 1.411 | 1.651 |
| | SbSI | 2.7 | 3.2 | 3.8 |
| | YAlO₃ | 1.923 | 1.938 | 1.947 |

In an embodiment where the external cavity is formed from glass, the crystal 402 may be epoxied to the glass, as is illustrated by the embodiment depicted in FIG. 4.

The crystal 402 is provided to impose a higher coupling loss on one of the orthogonal polarization states of the incident beam. It is contemplated that this may be accomplished through at least three methods. Each method will now be described in more detail. In each of the following methods, the external cavity is configured to discriminate against all but the TEM₀₀ mode.

1. Beam-Walkoff Aspect

In this method, the polarization state is controlled by causing the beam of desired polarization to follow an optical path through the cavity of low round-trip loss, whereas the beam with the undesired polarization follows a path of high round-trip loss. This loss can be manifested by a combination of mode-mismatch with the gain region, or instability in the resonator formed by that path. In this embodiment, the desired polarization state is predisposed to win competition for the gain volume.

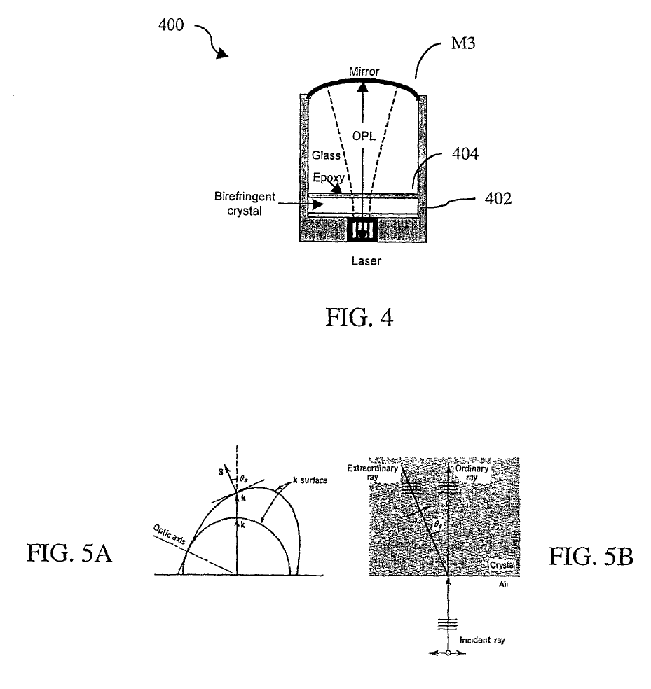

As depicted in FIGS. 5A-5C, the extraordinary polarized beam can be made to propagate at a predetermined angle with respect to the ordinary beam. The angle may be determined by the choice of orientation of the crystals fast axis. Factors influencing the choice of angle include: birefringence of crystal, total thickness of crystal, divergence of beam from source, and effect of competition from higher order modes.

The angle is determined from the fundamental kinematic condition imposed on the refracted waves at the incident surface:

kᵢ sin(θᵢ)=kₑ sin(θₑ)=kₒ sin(θₒ) Eq. 1

Where kᵢ, kₒ,kₑ, are the k wave vectors for the incident, ordinary, and extraordinary waves, and θᵢ, θₒ, θₑ are the angles, respectively.

FIGS. 5A and 5B illustrate double refraction depicted for a beam at normal incidence to a birefringent crystal, such as crystal 402. Note that the fast axis of the crystal has a predetermined orientation relative to incident beam.

FIG. 5C illustrates a ray trace plot for the ordinary and extraordinary polarized beams in an ECL with an internal Quartz crystal with fast axis oriented 45° to the cavity axis. Note the extraordinary beam does not mode match with the VCSEL aperture, whereas the ordinary beam does.

2. Differential Optical Path Length Used in Conjunction with a Mode-Locking Signal

In this embodiment, the fast axis of the crystal 402 is oriented perpendicular to that of the cavity. In this configuration the ordinary and extraordinary components of the incident beam co-propagate, however, they each experience a different index of refraction. Consequently, the two components will experience different optical path lengths as they traverse the crystal 402.

As is known by those skilled in the art, the longitudinal mode spacing (υ_{F}) is function of optical path length (OPL):

$${v}_{F} = \frac{{C}_{o}}{2 * OPL} [ Hz ] \qquad Eq . 2$$

Where Cₒ is the speed of light in vacuum, and OPL is the total cavity optical path length.

And,

$$OPL = {\sum }_{i = 1}^{N} {OPL}_{i} = {\sum }_{i = 1}^{N} {n}_{i} * {PPL}_{i} [ m ] \qquad Eq . 3$$

Where:

OPLᵢ is the optical path length of layer i;

i is the layer number;

nᵢ is the index of refraction of layer i; and

PPLᵢ is the physical path length of layer i.

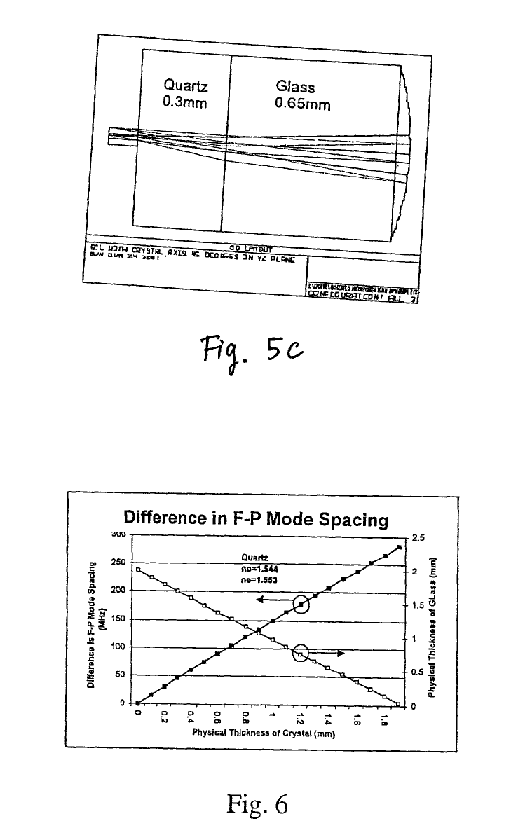

As will be appreciated by those of ordinary skill in the art, the orthogonal polarization states thus experience different Fabry-Perot mode spacing. The difference in frequency resulting from a thickness of quartz crystal is depicted in FIG. 6.

In this embodiment, extinction of the undesired polarization state can be achieved by frequency tuning a mode-locking drive source. It is contemplated that imparting a de-tuning of as much as 50 MHz between the VCSELs mode-locking signal (fundamental or higher harmonic) and the Fabry-Perot spacing of the ECL may introduce sufficient round-trip loss to prevent lasing. Additionally, to effectively apply this method, one may select and size the birefringent crystal to ensure the polarization dependent difference in the optical path length is sufficient to exceed the frequency miss-match criteria.

3. Fresnel Reflection Aspect

As will be appreciated by those skilled in the art, reflections at the birefringent crystal/epoxy interface typically will not be efficiently returned to the lasing mode. Thus, these reflections will constitute an optical loss. It is contemplated that by matching the index of refraction of the epoxy to the ordinary wave of the birefringent crystal, the losses of the mode with the desired polarization (the ordinary beam in one embodiment) may be eliminated. The extraordinary beam will then have measurably higher losses that will contribute to appropriate discrimination. Furthermore, the fraction of the energy which does return to the mode will either interfere constructively or destructively with the un-reflected mode. This is an etalon effect which can serve to enhance or reduce the effective external cavity feedback. By fine-tuning the diode injection current, the cavity length can be adjusted for destructive interference for the undesirable polarization.

While embodiments and applications of this disclosure have been shown and described, it would be apparent to those skilled in the art that many more modifications and improvements than mentioned above are possible without departing from the inventive concepts herein. The disclosure, therefore, is not to be restricted except in the spirit of the appended claims.

What is claimed is:

1. A light source, comprising:
a gain region defined by a first and second mirror, said gain region having a corresponding response shape;
an external cavity defined by a third mirror and said second mirror, said external cavity having a plurality of resonant modes; and
a birefringent crystal disposed within said external cavity.

2. The light source of claim 1, wherein said second mirror is formed such that said response shape of said gain region selects a single one of said plurality of modes.

3. The light source of claim 1, wherein said second mirror is formed such that said response shape of said gain region selects at least two of said plurality of modes.

4. The light source of claim 1, wherein said first mirror and the gain region is fabricated for use in the wavelength range of approximately 780-790 nm.

5. The light source of claim 1, wherein said first mirror and the gain region is fabricated for use in the wavelength range of approximately 1300-1700 nm.

6. The light source of claim 1, wherein said gain region response shape has a nominal peak wavelength of approximately 1550 nm.

7. The light source of claim 1, wherein said external cavity is greatly extended in length compared to said gain region.

8. The light source of claim 1, wherein the length of said external cavity has a length of approximately 2-3 mm.

9. The light source of claim 1, wherein said plurality of resonant modes have a mode spacing of approximately 100 GHz.

10. The light source of claim 1, wherein said plurality of resonant modes have a mode spacing of approximately 50 GHz.

11. The light source of claim 1, wherein said external cavity is filled with air and has a length of approximately 3 mm.

12. The light source of claim 1, wherein said external cavity comprises glass and has a length of approximately 2 mm.

13. The light source of claim 1, wherein the length of said external cavity has a length of approximately 4-6 mm.

14. The light source of claim 1, wherein said plurality of resonant modes have a mode spacing of approximately 25 GHz.

15. The light source of claim 1, wherein the length of said external cavity has a length of approximately 8-12 mm.

16. The light source of claim 1, wherein said plurality of resonant modes have a mode spacing of approximately 12.5 GHz.

17. The light source of claim 1, wherein said light source is configured for use in the wavelength range of 1550 nm.

18. The light source of claim 17, wherein said external cavity is configured to provide mode spacing corresponding to standard DWDM channel spacings.

19. The light source of claim 18, wherein said external cavity provides a mode spacing of 12.5 GHz.

20. The light source of claim 18, wherein said external cavity provides a mode spacing of 50 GHz.

21. The light source of claim 18, wherein said external cavity provides a mode spacing of 100 GHz.

22. The light source of claim 1, wherein said third mirror is configured to reflect incident light in the 1550 nm telcom band.

23. The light source of claim 1, wherein said third mirror has a radius of curvature equal to the length of said external cavity.

24. A light source, comprising:
a gain region defined by a first and second mirror, said gain region having a corresponding response shape;
an external cavity defined by a third mirror and said second mirror, said external cavity having a plurality of resonant modes; and
a birefringent crystal disposed within said external cavity configured to receive a light beam from said light source and refract said light beam into two orthogonal polarization states.

25. The light source of claim 24, wherein said light source is configured to cause one of said polarization states to follow an optical path of low round-trip loss, and the other said polarization state to follow a path of high round-trip loss.

26. The light source of claim 25, wherein said second mirror is formed such that said response shape of said gain region selects a single one of said plurality of modes.

27. The light source of claim 25, wherein said second mirror is formed such that said response shape of said gain region selects at least two of said plurality of modes.

28. The light source of claim 24, wherein said first mirror and the gain region is fabricated for use in the wavelength range of approximately 780-790 nm.

29. The light source of claim 24, wherein said first mirror and the gain region is fabricated for use in the wavelength range of approximately 1300-1700 nm.

30. The light source of claim 24, wherein said gain region response shape has a nominal peak wavelength of approximately 1550 nm.

31. The light source of claim 24, wherein said external cavity is greatly extended in length compared to said gain region.

32. The light source of claim 24, wherein the length of said external cavity has a length of approximately 2-3 mm.

33. The light source of claim 24, wherein said plurality of resonant modes have a mode spacing of approximately 100 GHz.

34. The light source of claim 24, wherein said plurality of resonant modes have a mode spacing of approximately 50 GHz.

35. The light source of claim 24, wherein said external cavity is filled with air and has a length of approximately 3 mm.

36. The light source of claim 24, wherein said external cavity comprises glass and has a length of approximately 2 mm.

37. The light source of claim 24, wherein the length of said external cavity has a length of approximately 4-6 mm.

38. The light source of claim 24, wherein said plurality of resonant modes have a mode spacing of approximately 25 GHz.

39. The light source of claim 24, wherein the length of said external cavity has a length of approximately 8-12 mm.

40. The light source of claim 24, wherein said plurality of resonant modes have a mode spacing of approximately 12.5 GHz.

41. The light source of claim 24, wherein said light source is configured for use in the wavelength range of 1550 nm.

42. The light source of claim 24, wherein said external cavity is configured to provide mode spacing corresponding to standard DWDM channel spacings.

43. The light source of claim 42, wherein said external cavity provides a mode spacing of 12.5 GHz.

44. The light source of claim 42, wherein said external cavity provides a mode spacing of 50 GHz.

45. The light source of claim 42, wherein said external cavity provides a mode spacing of 100 GHz.

46. The light source of claim 24, wherein said third mirror is configured to reflect incident light in the 1550 nm telcom band.

47. The light source of claim 24, wherein said third mirror has a radius of curvature equal to the length of said external cavity.

48. A light source, comprising:
a gain region defined by a first and second mirror, said gain region having a corresponding response shape;
an external cavity defined by a third mirror and said second mirror, said external cavity having a plurality of resonant modes; and
a birefringent crystal disposed within said external cavity configured to receive a light beam from said light source and refract said light beam into two orthogonal polarization states, wherein said birefringent crystal is oriented such that said polarization states experience different indices of refraction.

49. The light source of claim 48, wherein said second mirror is formed such that said response shape of said gain region selects a single one of said plurality of modes.

50. The light source of claim 48, wherein said second mirror is formed such that said response shape of said gain region selects at least two of said plurality of modes.

51. The light source of claim 48, wherein said first mirror and the gain region is fabricated for use in the wavelength range of approximately 780-790 nm.

52. The light source of claim 48, wherein said first mirror and the gain region is fabricated for use in the wavelength range of approximately 1300-1700 nm.

53. The light source of claim 48, wherein said gain region response shape has a nominal peak wavelength of approximately 1550 nm.

54. The light source of claim 48, wherein said external cavity is greatly extended in length compared to said gain region.

55. The light source of claim 48, wherein the length of said external cavity has a length of approximately 2-3 mm.

56. The light source of claim 48, wherein said plurality of resonant modes have a mode spacing of approximately 100 GHz.

57. The light source of claim 48, wherein said plurality of resonant modes have a mode spacing of approximately 50 GHz.

58. The light source of claim 48, wherein said external cavity is filled with air and has a length of approximately 3 mm.

59. The light source of claim 48, wherein said external cavity comprises glass and has a length of approximately 2 mm.

60. The light source of claim 48, wherein the length of said external cavity has a length of approximately 4-6 mm.

61. The light source of claim 48, wherein said plurality of resonant modes have a mode spacing of approximately 25 GHz.

62. The light source of claim 48, wherein the length of said external cavity has a length of approximately 8-12 mm.

63. The light source of claim 48, wherein said plurality of resonant modes have a mode spacing of approximately 12.5 GHz.

64. The light source of claim 48, wherein said light source is configured for use in the wavelength range of 1550 nm.

65. The light source of claim 48, wherein said external cavity is configured to provide mode spacing corresponding to standard DWDM channel spacings.

66. The light source of claim 65, wherein said external cavity provides a mode spacing of 12.5 GHz.

67. The light source of claim 65, wherein said external cavity provides a mode spacing of 50 GHz.

68. The light source of claim 65 wherein said external cavity provides a mode spacing of 100 GHz.

69. The light source of claim 48, wherein said third mirror is configured to reflect incident light in the 1550 nm telcom band.

70. The light source of claim 48, wherein said third mirror has a radius of curvature equal to the length of said external cavity.

71. A light source, comprising:
a gain region defined by a first and second mirror, said gain region having a corresponding response shape;
an external cavity defined by a third mirror and said second mirror, said external cavity having a plurality of resonant modes; and
a birefringent crystal disposed within said external cavity configured to receive a light beam from said light source and refract said light beam into two orthogonal polarization states, said birefringent crystal epoxied to said external cavity thereby forming a crystal/epoxy junction having an predetermined optical loss.

72. The light source of claim 71, wherein the index of refraction of said birefringent crystal is matched with said crystal/epoxy junction optical loss such that the losses of one of said polarization states is minimized.

73. The light source of claim 72, wherein said second mirror is formed such that said response shape of said gain region selects a single one of said plurality of modes.

74. The light source of claim 72, wherein said second mirror is formed such that said response shape of said gain region selects at least two of said plurality of modes.

75. The light source of claim 71, wherein said first mirror and the gain region is fabricated for use in the wavelength range of approximately 780-790 nm.

76. The light source of claim 71, wherein said first mirror and the gain region is fabricated for use in the wavelength range of approximately 1300-1700 nm.

77. The light source of claim 71, wherein said gain region response shape has a nominal peak wavelength of approximately 1550 nm.

78. The light source of claim 71, wherein said external cavity is greatly extended in length compared to said gain region.

79. The light source of claim 71, wherein the length of said external cavity has a length of approximately 2-3 mm.

80. The light source of claim 71, wherein said plurality of resonant modes have a mode spacing of approximately 100 GHz.

81. The light source of claim 71, wherein said plurality of resonant modes have a mode spacing of approximately 50 GHz.

82. The light source of claim 71, wherein said external cavity is filled with air and has a length of approximately 3 mm.

83. The light source of claim 71, wherein said external cavity comprises glass and has a length of approximately 2 mm.

84. The light source of claim 71, wherein the length of said external cavity has a length of approximately 4-6 mm.

85. The light source of claim 71, wherein said plurality of resonant modes have a mode spacing of approximately 25 GHz.

86. The light source of claim 71, wherein the length of said external cavity has a length of approximately 8-12 mm.

87. The light source of claim 71, wherein said plurality of resonant modes have a mode spacing of approximately 12.5 GHz.

88. The light source of claim 71, wherein said light source is configured for use in the wavelength range of 1550 nm.

89. The light source of claim 71, wherein said external cavity is configured to provide mode spacing corresponding to standard DWDM channel spacings.

90. The light source of claim 89, wherein said external cavity provides a mode spacing of 12.5 GHz.

91. The light source of claim 89, wherein said external cavity provides a mode spacing of 50 GHz.

92. The light source of claim 89, wherein said external cavity provides a mode spacing of 100 GHz.

93. The light source of claim 71, wherein said third mirror is configured to reflect incident light in the 1550 nm telcom band.

94. The light source of claim 71, wherein said third mirror has a radius of curvature equal to the length of said external cavity.
